(19) United States
(12) Patent Application Publication
(10) Pub. No.: US 2023/0368400 A1
(43) Pub. Date: Nov. 16, 2023

(54) TRACKING ARTICLES OF INTEREST IN MONITORED AREAS

(71) Applicant: ANC Group, LLC, Alexandria, VA (US)

(72) Inventors: Yotam Margalit, Livermore, CA (US); Eshed Margalit, Livermore, CA (US); Amir Neeman, Alexandria, VA (US)

(21) Appl. No.: 17/741,529

(22) Filed: May 11, 2022

(51) Int. Cl. G06T 7/246; G06T 7/70; G06V 20/52; G06V 10/74; G06V 10/764; G06F 16/58

(52) U.S. Cl. CPC G06T 7/248; G06T 7/70; G06V 20/52; G06V 10/74; G06V 10/764; G06F 16/5866; G06T 2207/30232

(57) ABSTRACT

Systems, methods, and computer program products for monitoring an area. A data collection and analysis system includes a plurality of data collection devices. Each data collection device includes an imaging unit that captures images of the area. The system receives time-stamped images from the imaging units and identifies the articles of interest in the images. The system further determines a spatial location of each article of interest identified based at least in part on a location of the article of interest in the image and the location of the portion of the area in the image. Each article of interest is associated with its spatial location and the time stamp of the image in which it was identified in a database. In response to receiving a query associated with an article of interest at the database, the system displays a timeline for the article of interest.

### BACKGROUND

This invention generally relates to surveillance systems and, in particular, to methods, systems, and computer program products for collecting and analyzing data related to articles of interest passing through monitored areas.

Commercial transportation has long been a target for robbers, highjackers, terrorists, and other malefactors. Accordingly, security processes have been developed to prevent malefactors from gaining access to trains, ships, aircraft, and other means of transportation. These processes typically involve creation of secure areas in and around points of departure, and screening passengers as they pass through security checkpoints that guard the entrances to these areas. At the security checkpoint, each passenger is typically required to present a valid identification along with a ticket or boarding pass. Each passenger must also typically place their carry-on bags and other personal items into bins that are passed through a baggage scanner, as well as personally pass through some type of body scanning system. The large number of passengers passing through a typical security checkpoint make it difficult to keep track of where each passenger and their items are at any given point in time. This problem of tracking passengers and items passing through security checkpoints is particularly difficult when a disruption occurs that demands the attention of security personnel. Failure to track all passengers and their items may lead to security breaches in which prohibited items or unauthorized persons are able to pass through the security checkpoint.

Thus, there is a need for improved systems, methods, and computer program products for tracking passengers and their items in monitored areas.

### SUMMARY

In an embodiment of the invention, a system for monitoring an area is provided. The system includes one or more imaging units each configured to capture images of at least a portion the area, an article of interest in the area, or both the portion of the area and the article of interest. The system further includes one or more processors in communication with the one or more imaging units, and a memory coupled to the one or more processors and including program code. The program code is configured so that, when it is executed by the one or more processors, it causes the system to receive a first image of a plurality of images of the area. Each of the plurality of images includes a time stamp, and the system identifies a first article of interest in the first image, determines a spatial location of the first article of interest based at least in part on an image location of the first article of interest in the first image, associates the first article of interest with the time stamp of the first image and the spatial location in a database, and in response to receiving a query associated with the first article of interest at the database, displays a timeline for the first article of interest.

In an aspect of the invention, the plurality of images may include both visible light images and non-visible light images.

In another aspect of the invention, the first image may be a visible light image and the first article of interest may correspond to a personal item. The program code may further cause the system to identify a second article of interest in the first image corresponding to a visual identifier tag that identifies a bin holding the first article of interest, receive a second image of the plurality of images of the area, the second image being a non-visible light image, identify a third article of interest in the second image corresponding to a non-visual identifier tag that identifies the bin holding the first article of interest, and determine the first article of interest in the first image corresponds to the first article of interest in the second image based at least in part on both the visual identifier tag and the non-visual identifier tag being associated with the bin holding the first article of interest.

In another aspect of the invention, the program code may further cause the system to determine if the first article of interest has been previously identified in at least one other image of the plurality of images. In response to the first article of interest having been previously identified in the at least one other image, the program code may cause the system to associate the first article of interest in the first image with a first identifier previously associated with the first article of interest. In response to the first article of interest not having been previously identified, the program code may cause the system to generate a second identifier different from each identifier associated with one or more other previously identified articles of interest, and associate the first article of interest in the first image with the second identifier.

In another aspect of the invention, the program code may cause the system to determine if the first article of interest has been previously identified in the at least one other image of the plurality of images by calculating a first feature descriptor for the first article of interest, determining if the first feature descriptor matches any previously calculated feature descriptor, if the first feature descriptor matches any previously calculated feature descriptors, determining the first article of interest has been previously identified in the at least one other image, and if the first feature descriptor does not match any previously calculated feature descriptors, determining the first article of interest has not been previously identified in the at least one other image.

In another aspect of the invention, the program code may cause the system to identify the first article of interest in the first image by calculating a feature descriptor for each of a plurality of image segments of the first image, and classifying the feature descriptor of a first image segment of the plurality of image segments as belonging to a class of articles including the first article of interest.

In another aspect of the invention, the program code may further cause the system to display a bounding box around the first image segment in the first image, and transmit the query associated with the first article of interest to the database in response to a user selecting the bounding box.

In another embodiment of the invention, a method of monitoring an area is provided. The method includes receiving the first image of the plurality of images of the area, identifying the first article of interest in the first image, determining the spatial location of the first article of interest based at least in part on the image location of the first article of interest in the first image, associating the first article of interest with the time stamp of the first image and the spatial location in a database, and in response to receiving the query associated with the first article of interest at the database, displaying the timeline for the first article of interest.

In another aspect of the invention, the first image may be the visible light image, the first article of interest may correspond to the personal item, and method may further include identifying a second article of interest in the first image corresponding to the visual identifier tag that identifies the bin holding the first article of interest, receiving the second image of the plurality of images of the area, identifying the third article of interest in the second image corresponding to the non-visual identifier tag that identifies the bin holding the first article of interest, and determining the first article of interest in the first image corresponds to the first article of interest in the second image based at least in part on both the visual identifier tag and the non-visual identifier tag being associated with the bin holding the first article of interest.

In another aspect of the invention, the method may further include determining if the first article of interest has been previously identified in at least one other image of the plurality of images, in response to the first article of interest having been previously identified in the at least one other image, associating the first article of interest in the first image with the first identifier previously associated with the first article of interest, in response to the first article of interest not having been previously identified, generating the second identifier different from each identifier associated with one or more other previously identified articles of interest, and associating the first article of interest in the first image with the second identifier.

In another aspect of the invention, determining if the first article of interest has been previously identified in the at least one other image of the plurality of images may include calculating the first feature descriptor for the first article of interest, and determining if the first feature descriptor matches any previously calculated feature descriptor. If the first feature descriptor matches any previously calculated feature descriptors, the method may determine the first article of interest has been previously identified in the at least one other image. If the first feature descriptor does not match any previously calculated feature descriptors, the method may determine the first article of interest has not been previously identified in the at least one other image.

In another aspect of the invention, identifying the first article of interest in the first image may include calculating a feature descriptor for each of the plurality of image segments of the first image, and classifying the feature descriptor of the first image segment of the plurality of image segments as belonging to the class of articles including the first article of interest.

In another aspect of the invention, the method may further include displaying a bounding box around the first image segment in the first image, and transmitting the query associated with the first article of interest to the database in response to the user selecting the bounding box.

In another embodiment of the invention, a computer program product for monitoring an area is provided. The computer program product includes a non-transitory computer-readable storage medium and program code stored on the non-transitory computer-readable storage medium. The program code is configured so that when it is executed by one or more processors, the program code causes the one or more processors to receive the first image of the plurality of images of the area, identify the first article of interest in the first image, determine the spatial location of the first article of interest based at least in part on the image location of the first article of interest in the first image, associate the first article of interest with the time stamp of the first image and the spatial location in the database, and in response to receiving the query associated with the first article of interest at the database, display the timeline for the first article of interest.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a perspective view of an exemplary operating environment including a security checkpoint.

FIG. 2 is a schematic view of a data collection and analysis system, a security checkpoint system, and a travel provider system that support the security checkpoint of FIG. 1.

FIG. 3 is a schematic view showing additional details of the data collection and analysis system of FIG. 2.

FIG. 4 is a diagrammatic view of a bin that includes identifier tags and which may be used by the security checkpoint of FIG. 1.

FIG. 5 is a diagrammatic view showing additional details of the identifier tag of FIG. 4.

FIGS. 6-8 are diagrammatic views of a fixed data collection device of the data collection and analysis system of FIGS. 2 and 3.

FIG. 9 is a graphical view illustrating images that may be collected by the fixed data collection devices of FIGS. 6-8.

FIG. 10 is a flowchart of a process for monitoring an area using the data collection and analysis system of FIG. 2.

FIG. 11 is a schematic view of a computer that may be used to implement one or more of the components or processes shown in FIGS. 1-10.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding. In particular, thin features may be thickened, for example, for clarity or illustration.

### DETAILED DESCRIPTION

Embodiments of the invention are directed to a data collection and analysis system. The data collection and analysis system uses image analytics to track “articles of interest” (e.g., passengers, airport personnel, passenger baggage, and any bins into which bags or other personal items are placed) based on images which are collected by one or more data collection devices. The collected images are run through image analysis systems that generate unique identifiers. These unique identifiers are associated with the articles of interest throughout the screening process. The data collection and analysis system identifies and re-identifies passengers and their items as they move through the checkpoint, and assigns time and location stamps to each article of interest along the way. An analysis of the image data generates time and movement information about passengers and their items throughout the screening process. The image data may also be integrated with data collected by transportation security equipment, e.g., X-ray images, field data reporting systems, etc.

For purposes of clarity and conciseness, embodiments of the invention are described herein largely in the context of an airport security system. However, it should be understood that embodiments of the invention are not limited to any specific type of security system or field of use, and that other use contexts are envisioned, such as but not limited to monitored areas (both secure and non-secure) at airports, seaports, public buildings, public transportation facilities, prisons, hospitals, power plants, office buildings, hotels, casinos, sports and concert venues, or any other areas or events requiring security.

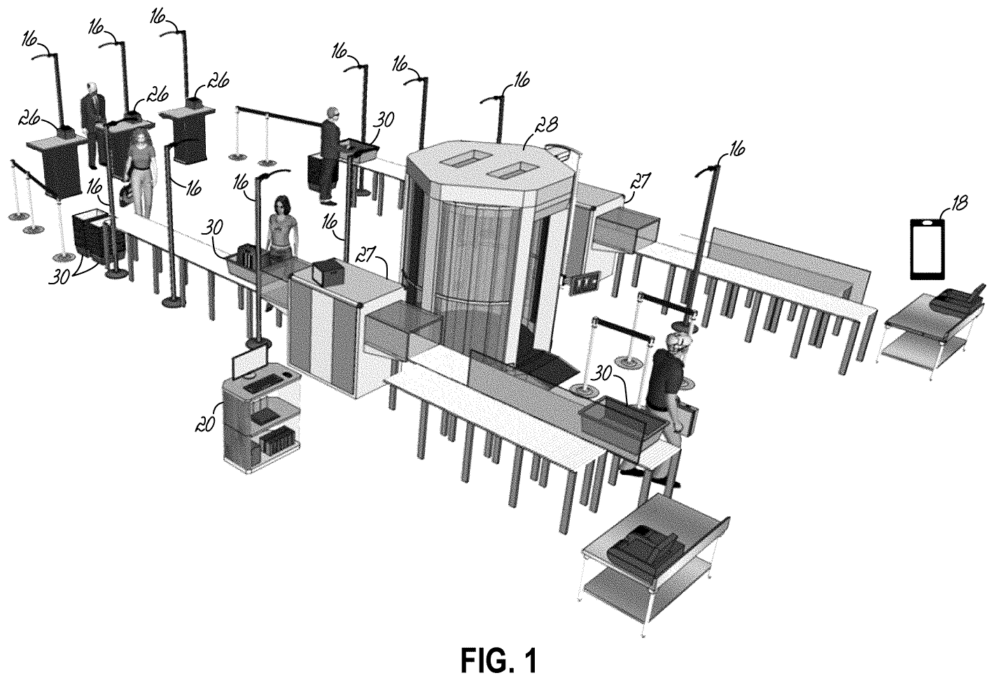

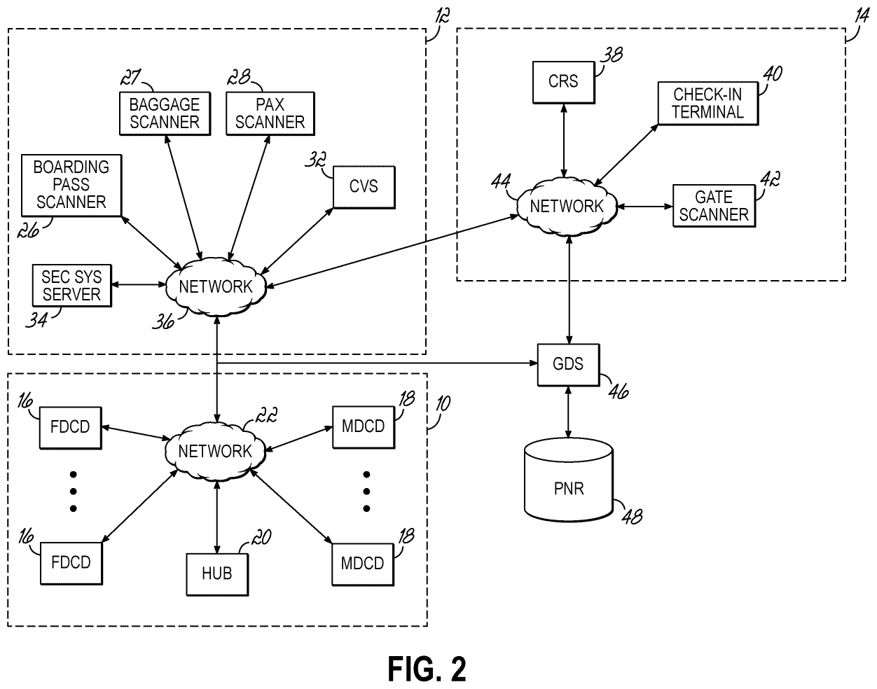

FIG. 1 depicts an exemplary security checkpoint (e.g., an airport security checkpoint) including a data collection and analysis system 10, and FIG. 2 presents a block diagram of the data collection and analysis system 10, a security checkpoint system 12, and a travel provider system 14 in accordance with an embodiment of the invention. The data collection and analysis system 10 may include one or more data collection devices 16, 18. The data collection devices 16, 18 may include fixed data collection devices 16 and mobile data collection devices 18 each in communication with a system hub 20 through a data network 22. The data network 22 may communicate using any suitable wired or wireless network protocol, such as one of the Institute of Electrical and Electronics Engineers (IEEE) 802 communication standards. Data networks are well known in the computer industry, and a further description of data networks is therefore not included herein.

The fixed data collection devices 16 may include network enabled battery powered imaging units (e.g., an internet protocol (IP) camera), and may be placed on poles or otherwise elevated above areas to be monitored. The fixed data collection devices 16 may collect images, extract passenger and item information therefrom, and transmit the images and/or extracted information to the system hub 20. Images may be captured periodically (e.g., once a second) as still images or as a video stream. However, it should be appreciated that embodiments of the invention are not limited to any particular rate of collecting images.

The mobile data collection devices 18 may be implemented by loading an application onto a portable computing device, such as a smartphone or tablet computer. The mobile data collection devices 18 may be used during an alarm resolution process, for example, to capture the type of alarm, the action taken to address the alarm, and the results of the action taken. The mobile data collection devices 18 may timestamp each action taken and capture images of each item flagged. To begin documenting the information and timestamps for each alarmed item, the user of the mobile data collection device 18 may select an icon or otherwise cause the user interface of the device to activate the application. For each action log, the data collection device 18 may capture a bin identifier, an item number, choose an identifier, and then take an image of the item. As the item is moved through alarm resolution, the data collection device 18 may also record timestamps for each action taken.

The system hub 20 may use time and movement information extracted from the images to track passengers and their baggage as they pass through the monitored area. To this end, the system hub 20 may include a database management server and associated database, such as SQL Server®, available from the Microsoft Corporation of Redmond Washington. The database server may be responsible for importing, storing, processing, and reporting on the data collected by the data collection and analysis system 10 during checkpoint operations. Data imported by the database server may include sensor data along with boarding pass data, X-ray images, X-ray image annotations, secondary images, secondary scan results, and checkpoint passenger bin content. This data may be processed to create a direct relationship between a passenger and their detailed security scan results.

The database server may support detailed reporting on checkpoint operational metrics. All charts and tables created through these reports may be exportable to other applications, such as a spreadsheet. The database server may also support displaying raw data including boarding passes, X-ray images, secondary images, and secondary scan results data. The system hub 20 may also include a data management software application that allows for database management and report generation. In addition, the system hub 20 may host an application that checks the current health status of the data collection devices 16, 18. In response to a data collection device having an issue, the system hub 20 may display an alert identifying the data collection device in question and a reason for issuing the alert.

The security checkpoint system 12 may include a boarding pass scanner 26, baggage scanner 27 (e.g., an X-ray and/or explosives scanner), a passenger scanner 28, bins 30 configured to hold items being passed through the baggage scanner 27, a common viewing station 32 that enables users to view image data, and a security system server 34 in communication with the scanners 26-28 and common viewing station 32 through a data network 36. The boarding pass scanner 26 may include a barcode scanning window, a full-graphic display, and multicolor light emitting diodes for a fast and clear GO/NO-GO decision. The boarding pass scanner 26 may read passenger boarding passes, passports and ID cards, and may include an embedded computer.

The travel provider system 14 may include an Airline computer reservation system 38 in communication with a check-in terminal 40 and a gate scanner 42 over a data network 44. The security system server 34 and computer reservation system 38 may also be in communication with a global distribution system 46 that maintains a passenger name record database 48. Computer reservation and global distribution systems are well known in the travel industry, and a further description of these systems is therefore not included herein.

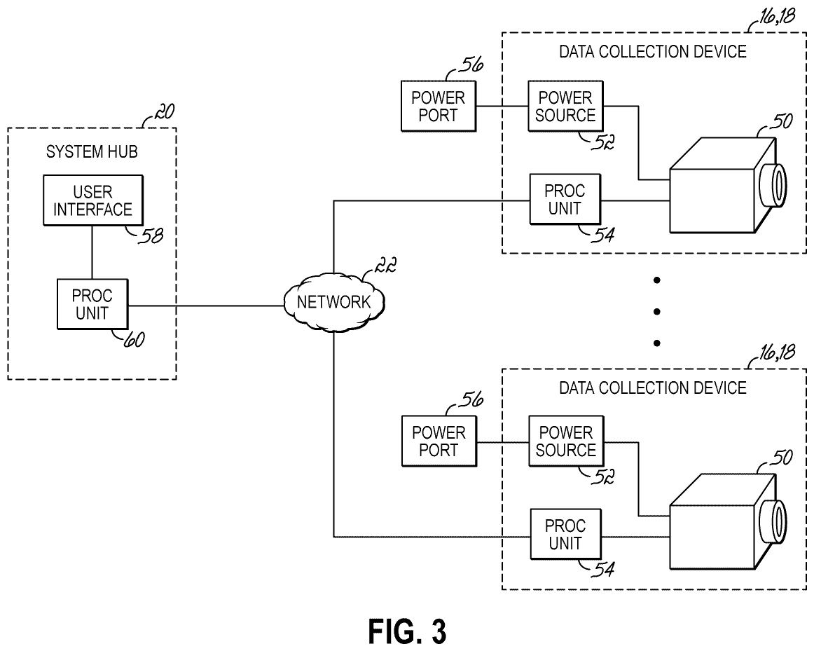

FIG. 3 depicts the data collection devices 16, 18 and system hub 20 in additional detail. Each data collection device 16, 18 may include an imaging unit 50, a power source 52, and a processing unit 54. The power source 52 may be operatively coupled to a power port 56, and may include an energy storage device (e.g., a battery, super capacitor, etc.) and/or voltage regulation circuitry configured to provide the imaging unit 50 and processing unit 54 with electrical power. The power port 56 may be configured to receive external power through an electrical cable, inductively, or by any other suitable means. The power source 52 may use the power received through the power port 56 to charge the energy storage device and/or provide power directly to the imaging unit 50 and processing unit 54. The system hub 20 may include a user interface 58 operatively coupled to a processing unit 60 that communicates with the data collection devices 16, 18 via the data network 22.

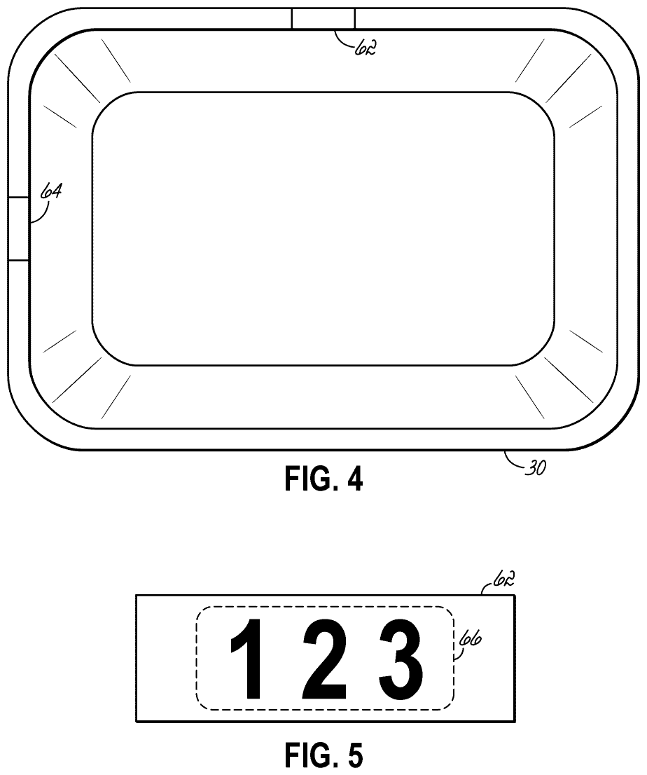

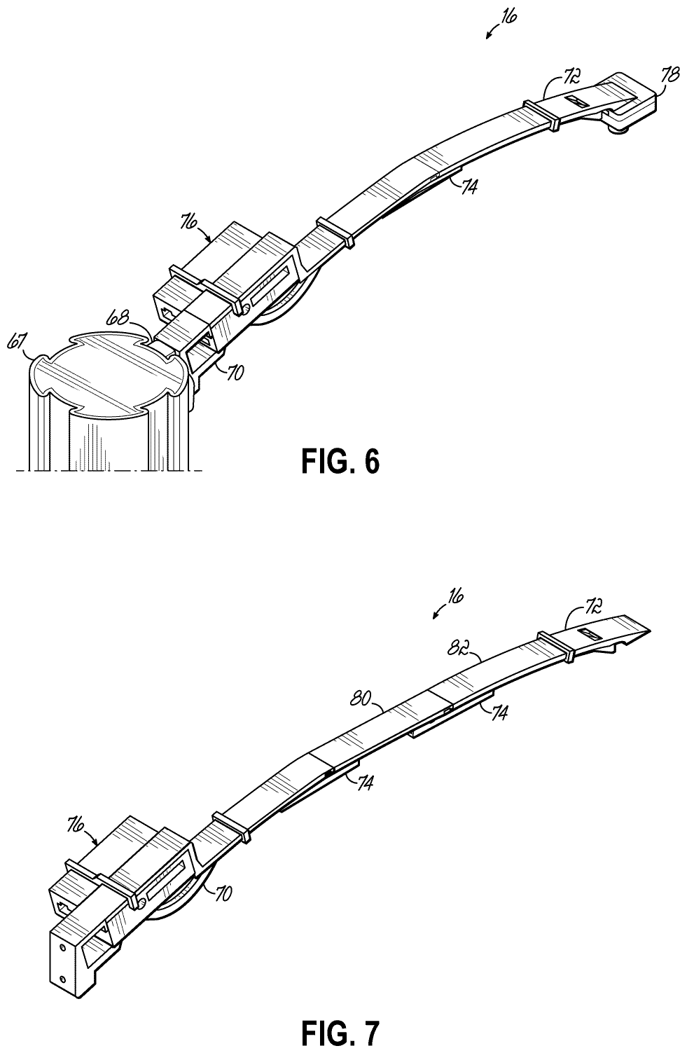

FIG. 4 presents a top view of an exemplary bin 30 showing a visual identifier tag 62 (e.g., a tag visible to an imaging unit 50) and a non-visual identifier tag 64 (e.g., a tag visible in an X-ray scanner or other device that uses something other than light to form images). FIG. 5 presents a diagrammatic view of an exemplary identifier tag 62, 64 in more detail. Although depicted as having one of each type of identifier tag 62, 64, it should be appreciated that bins 30 may include multiple visual and non-visual identifier tags 62, 64 to increase the likelihood that at least one of each tag can be imaged by one of the data collection devices 16, 18 or baggage scanner 27, respectively. It should also be appreciated that although the visual and non-visual identifier tags 62, 64 are shown as separate tags, they may be integrated into a single tag, or may be separate tags co-located in the same position on the bin 30. Each identifier tag 62, 64 may include an indicia 66 comprising one or more symbols and/or marks that uniquely identifies the bin 30 to which it is attached. The indicia 66 may be configured to be identifiable from multiple angles, and may include redundant information for purposes of error checking. The indicia 66 may include a character string (shown), a barcode, quick response (QR) code, or any other pattern or code that can be used to uniquely identify the bin 30 in a visible light image, an X-ray image, or an image captured using any other type of imaging technology.

The indicia 66 of the visual identifier tag 62 may be printed on the tag using a contrasting material (e.g., ink) that is visibly distinct from the background to the imaging units 50 of the data collection devices 16, 18. The indicia 66 of the non-visual identifier tag 64 may be defined by areas that are relatively opaque to (or reflective of) X-rays, such as metallic films or objects. These areas of relatively high density may be embedded in a material that is relatively transparent to X-rays (e.g., plastic) and arranged in a different unique pattern for each bin 30 so that the pattern can be used to uniquely identify the bin 30 as it passes through the baggage scanner 27.

The common viewing station 32 may enable system users to view and inspect three dimensional (volumetric) X-ray image data obtained from the baggage scanner 27 in real time. The 3-D data generated by the baggage scanner 27 may be imported in a standard digital imaging and communication in security (DICOS) file format, or any other suitable data file format. This 3-D data may be visualized in a range of 2-D (slice) or 3-D (volumetric) rendered image viewing panes and graphical user interface layouts. X-ray imaging may be used for both checked baggage screening as well as personal carry-on items at the security checkpoint. In either case, baggage and other personal items may be scanned volumetrically, and each resulting image comprised of hundreds or thousands of 2-D slices. These 2-D slices together form a 3-D image which is rendered in 3-D in the common viewing station 32 using volume rendering, maximum intensity projection, or any other suitable rendering technique. The 3-D data provided for visualization may be stored onto a local volume or remote server, and may be accessed by the common viewing station 32 in pseudo real-time (on-line) or at a later time (off-line) to inspect and resolve each scan. The volumetric data may then be processed by the common viewing station 32 to present to the user for visualization. The common viewing station 32 may also be equipped with a built-in automated threat recognition feature. The automated threat recognition feature may be activated, for example, based on the characteristics of an item in an image matching those of a prohibited item.

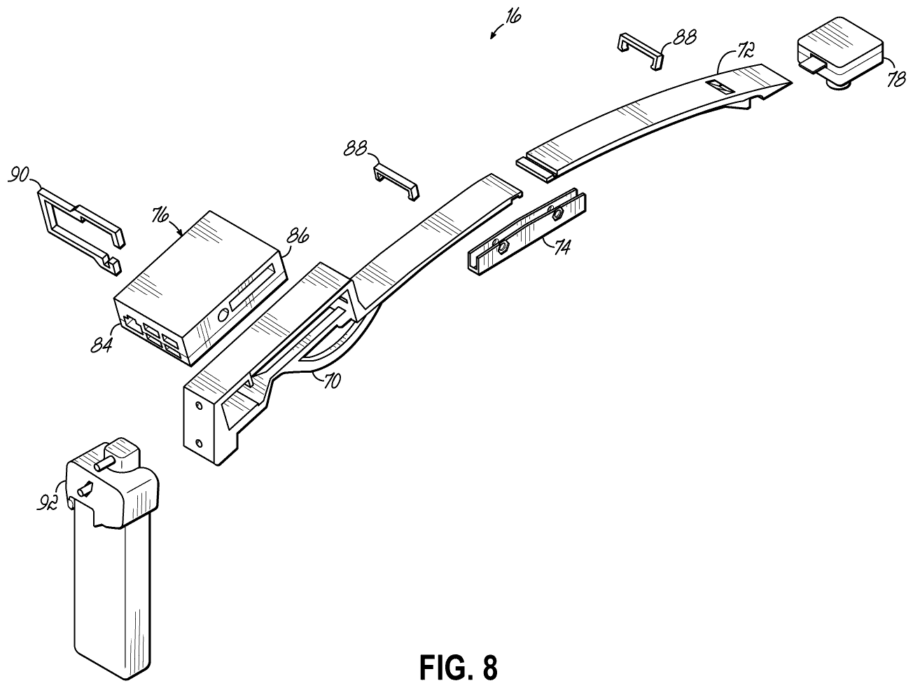

FIG. 6 depicts an exemplary data collection device 16 operatively coupled to a pole 67 by a mount 68. The data collection device 16 includes a base 70, an arm 72 operatively coupled to the base 70 by one or more connectors 74, a processing unit 76, and an imaging unit 78. The base 70 may include a cavity configured to hold the processing unit 76, and the imaging unit 78 may be attached to a distal end of the arm 72. The arm 72 may be configured to position the imaging unit 78 in an advantageous vantage point from which to capture images of the security check point.

FIG. 7 depicts a partially assembled data collection device 16 including optional inner and outer extensions 80, 82. The extensions 80, 82 may be used to operatively couple the arm 72 to the base 70 in cases where it is desirable to position the imaging unit 78 further from the pole 67 than would otherwise be possible. FIG. 8 depicts the data collection device 16 in an exploded view including the base 70, arm 72, connectors 74, a top portion 84 and a bottom portion 86 of a housing of processing unit 76, a data cable clip 88, a base clip 90, and a battery cover 92.

As passengers enter the security checkpoint, they may be directed to present a boarding pass, personal identification, and/or other documentation to the boarding pass scanner 26. This documentation may be scanned by the boarding pass scanner 26 and the information contained therein extracted. This extracted information may be forwarded to the security system server 34. The security system server 34 may then authenticate the passenger based at least in part on a comparison between the extracted information and passenger information received from one or more of the travel provider system 14 and global distribution system 46.

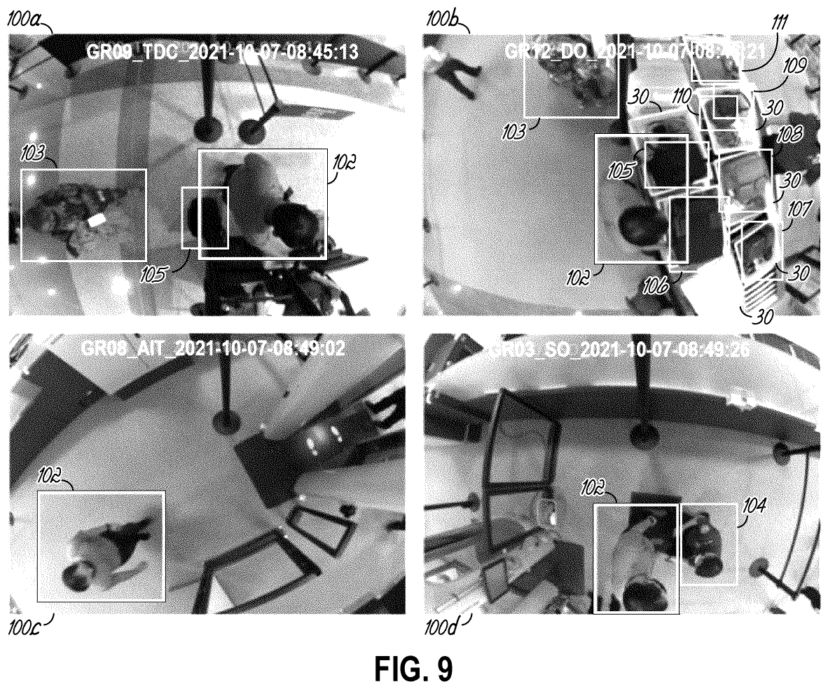

Referring now to FIG. 9, one or more of the data collection devices 16 may capture images 100a-100d that include the passengers as they proceed through the security checkpoint. The data collection devices 16 may be configured to capture images 100a-100d from an elevated position. An elevated position may be used, for example, to provide a good vantage point for determining the spatial location of passengers and their items. The data collection and analysis system 10 may analyze each image 100a-100d and identify any portions of the image or “image segments” corresponding to an article of interest detected therein. Each image segment corresponding to an article of interest may be identified in its respective image 100a-100d by a respective bounding box 102-111. The exemplary image segments identified as corresponding to an article of interest in the images 100a-100d may correspond to passengers (bounding boxes 102, 103), a security checkpoint employee (bounding box 104), personal items brought into the monitored area by the passengers (bounding boxes 105-111), as well as bins 30, visual identifier tags 62, and non-visual identifier tags 64.

The image data collected/generated by the data collection devices 16, 18 may be transmitted to the system hub 20. The system hub 20 may then convert the image data to per-article-associated-time-and-location information. This conversion process may use a suitable image analysis algorithm to identify image segments in the images corresponding to articles of interest. Once identified, each article of interest may be associated with time stamps and locations relating to each image in which it appears to establish a timeline for that article of interest. The timeline may be presented, for example, in the form of a table, chart, map, thumbnail images, etc. showing the time and location of the article of interest for a period of time during which it was in the monitored area.

Articles of interest may also be associated with information from the security checkpoint system 12, the travel provider system 14, and/or global distribution system 46. For example, passenger identities extracted by the boarding pass scanner 26 may be associated with articles of interest identified in the images 100a-100d based on timing and proximity of the article of interest to the boarding pass scanner 26 while a document is being scanned. Information about the passenger's itinerary from the travel provider system 14 and/or global distribution system 46 may then be used to predict where the passenger is likely to go after leaving the security checkpoint. Deviations from the expected path could, for example, trigger an alert. An article of interest identified as a bag that becomes separated from the article of interest identified as the bag's owner may also trigger an alert. Articles of interest may also be reidentified within chronological collections of images 100a-100d. Once an article of interest has been identified, it may be associated with each location in which it has been imaged as well as the time it was imaged in that location. This location and time information may then be used to produce a complete timeline for the article of interest while it is in the monitored area, and to alert security personnel to suspicious activities.

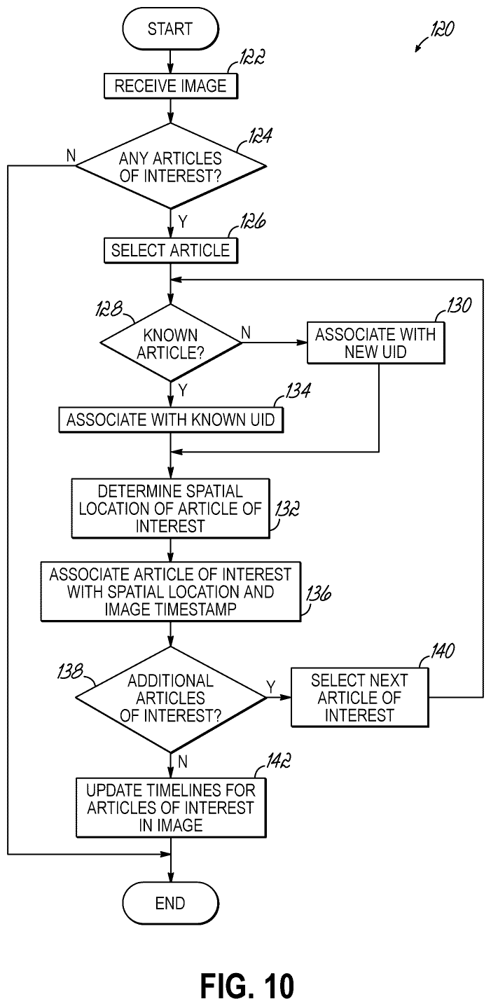

FIG. 10 depicts a flowchart illustrating a monitoring process 120 that may be implemented by one or more of the processing units 54 of data collection devices 16, 18, the system hub 20, or any other suitable computer of the data collection and analysis system 10. In block 122, the process 120 receives an image 100 captured by the imaging unit 50 of one of the data collection devices 16, 18. In response to receiving the image, the process 120 may proceed to block 124 and determine if there are any articles of interest in the image 100. To this end, the process 120 may identify any image segments that contain an article of interest and assign a label to the identified image segments, e.g., person, bag, etc. For each image segment so identified, the process 120 may calculate a feature descriptor. Each feature descriptor may comprise a vector that describes the content of the image segment occupied by the respective article of interest. Feature descriptors may be used to classify an article of interest into a class of articles (e.g., person, personal item, etc.). These feature descriptors may also be sufficiently unique to each article of interest to provide a means of identifying a particular article of interest that appears in different images, as well as different articles within a single class of articles.

To classify or identify a particular article of interest, the feature descriptor for the image segment corresponding to the article of interest may be compared to one or more feature descriptors that identifies a class of articles, or that was previously calculated for an image segment of another image. If the distance (e.g., Euclidean distance) between two feature descriptors is less than a predetermined threshold, the feature descriptors may be considered as matching either the class of articles or the previously identified article of interest. The distance threshold for matching a calculated feature descriptor to a classifying feature descriptor may be larger than the distance threshold for matching the calculated feature descriptor to a previously calculated feature descriptor. If the identifying descriptor is determined to match the previously calculated feature descriptor, the article of interest may be identified as the same article of interest identified in the previous image. Methods of detecting and/or identifying articles of interest within images are well known in the field of image processing, and any suitable method may be used, such as the methods disclosed by U.S. Pat. No. 8,165,397 to Doretto et al., which is incorporated by reference herein in its entirety.

If no articles of interest are detected (“NO” branch of decision block 124), the process 120 may terminate until another image is received. If one or more articles of interest are identified in the image 100 (“YES” branch of decision block 124), the process 120 may proceed to block 126 and select an article of interest from the image 100. In block 128, the process 120 may determine if the selected article of interest is one that is already known to the system. This may be determined, for example, by comparing the characteristics of the article of interest extracted from the selected image to the characteristics of articles of interest extracted from other processed images, e.g., as described above. If the selected article of interest is not known (“NO” branch of decision block 128), the process 120 may proceed to block 130 and associate the article with a new unique identifier. If the selected article of interest is known (“YES” branch of decision block 128), the process 120 may proceed to block 134 and associate the article of interest with an existing unique identifier previously associated with the article of interest.

In block 132, the process 120 may determine a spatial location for the article of interest. The spatial location may be determined, for example, based on one or more of a known location of the area imaged by data collection device 16, 18 from which the image was received, the location of the article of interest within the received image (i.e., the image location of the article of interest), and/or the image location of the article of interest within one or more other images from other data collection devices 16, 18 that overlap and/or have times stamps close to (e.g., within one second of) the time stamp of the received image.

Once the spatial location of the article of interest has been determined, the process 120 may proceed to block 136 and associate the article of interest with its spatial location and/or a timestamp of the image in question. This association may be defined, for example, by updating a database record associated with the article of interest to reflect the presence of the article of interest at the determined spatial location at the time indicated by the time stamp of the received image.

In block 138, the process 120 may determine if there are any additional articles of interest in the received image that have yet to be associated with a spatial location and/or image time stamp. If there are additional articles of interest in the image (“YES” branch of decision block 138), the process 120 may proceed to block 140, select the next article of interest, and return to block 128. If no additional articles of interest remain to be processed (“NO” branch of decision block 138), the process 120 may proceed to block 142 and update the timeline of each article of interest identified in the received image to reflect the spatial location of the article at the time the received image was captured.

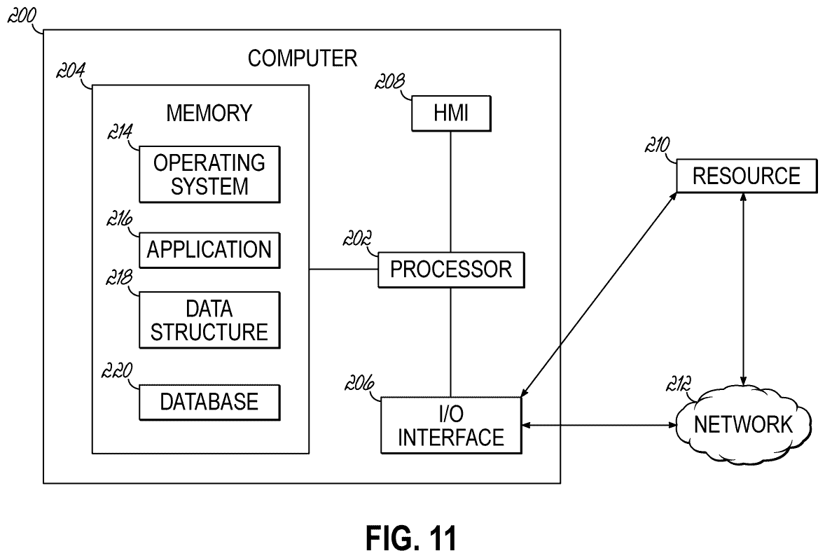

Referring now to FIG. 11, embodiments of the invention described above, or portions thereof (such as the processing units), may be implemented using one or more computer devices or systems, such as exemplary computer 200. The computer 200 may include a processor 202, a memory 204, an input/output (I/O) interface 206, and a Human Machine Interface (HMI) 208. The computer 200 may also be operatively coupled to one or more external resources 210 via the network 212 or I/O interface 206. External resources may include, but are not limited to, servers, databases, mass storage devices, peripheral devices, cloud-based network services, or any other resource that may be used by the computer 200.

The processor 202 may include one or more devices selected from microprocessors, micro-controllers, digital signal processors, microcomputers, processing units, field programmable gate arrays, programmable logic devices, state machines, logic circuits, analog circuits, digital circuits, or any other devices that manipulate signals (analog or digital) based on operational instructions stored in memory 204. Memory 204 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 202 may operate under the control of an operating system 214 that resides in memory 204. The operating system 214 may manage computer resources so that computer program code embodied as one or more computer software applications, such as an application 216 residing in memory 204, may have instructions executed by the processor 202. In an alternative embodiment, the processor 202 may execute the application 216 directly, in which case the operating system 214 may be omitted. One or more data structures 218 may also reside in memory 204, and may be used by the processor 202, operating system 214, or application 216 to store or manipulate data.

The I/O interface 206 may provide a machine interface that operatively couples the processor 202 to other devices and systems, such as the external resource 210 or the network 212. The application 216 may thereby work cooperatively with the external resource 210 or network 212 by communicating via the I/O interface 206 to provide the various features, functions, applications, processes, or modules comprising embodiments of the invention. The application 216 may also have program code that is executed by one or more external resources 210, or otherwise rely on functions or signals provided by other system or network components external to the computer 200. Indeed, given the nearly endless hardware and software configurations possible, persons having ordinary skill in the art will understand that embodiments of the invention may include applications that are located externally to the computer 200, distributed among multiple computers or other external resources 210, or provided by computing resources (hardware and software) that are provided as a service over the network 212, such as a cloud computing service.

The HMI 208 may be operatively coupled to the processor 202 of computer 200 to allow a user to interact directly with the computer 200. The HMI 208 may include video or alphanumeric displays, a touch screen, a speaker, and any other suitable audio and visual indicators capable of providing data to the user. The HMI 208 may also include input devices and controls such as an alphanumeric keyboard, a pointing device, keypads, pushbuttons, control knobs, microphones, etc., capable of accepting commands or input from the user and transmitting the entered input to the processor 202.

A database 220 may reside in memory 204, and may be used to collect and organize data used by the various systems and modules described herein. The database 220 may include data and supporting data structures that store and organize the data. In particular, the database 220 may be arranged with any database organization or structure including, but not limited to, a relational database, a hierarchical database, a network database, or combinations thereof. A database management system in the form of a computer software application executing as instructions on the processor 202 may be used to access the information or data stored in records of the database 220 in response to a query, which may be dynamically determined and executed by the operating system 214, other applications 216, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the flow-charts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flow-charts, sequence diagrams, or block diagrams.

In certain alternative embodiments, the functions, acts, or operations specified in the flow-charts, sequence diagrams, or block diagrams may be re-ordered, processed serially, or processed concurrently consistent with embodiments of the invention. Moreover, any of the flow-charts, sequence diagrams, or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include both the singular and plural forms, and the term “or” is intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for monitoring an area, comprising:
one or more imaging units each configured to capture images of at least a portion the area, an article of interest in the area, or both the at least a portion of the area and the article of interest;
one or more processors in communication with the one or more imaging units; and
a memory coupled to the one or more processors and including program code that, when executed by the one or more processors, causes the system to:
receive a first image of a plurality of images of the area, each of the plurality of images including a time stamp;
identify a first article of interest in the first image;
determine a spatial location of the first article of interest based at least in part on an image location of the first article of interest in the first image;
associate the first article of interest with the time stamp of the first image and the spatial location in a database; and
in response to receiving a query associated with the first article of interest at the database, display a timeline for the first article of interest.

2. The system of claim 1, wherein the plurality of images includes both visible light images and non-visible light images.

3. The system of claim 2, wherein the first image is a visible light image, the first article of interest corresponds to a personal item, and the program code further causes the system to:
identify a second article of interest in the first image corresponding to a visual identifier tag that identifies a bin holding the first article of interest;
receive a second image of the plurality of images of the area, the second image being a non-visible light image;
identify a third article of interest in the second image corresponding to a non-visual identifier tag that identifies the bin holding the first article of interest; and
determine the first article of interest in the first image corresponds to the first article of interest in the second image based at least in part on both the visual identifier tag and the non-visual identifier tag being associated with the bin holding the first article of interest.

4. The system of claim 1, wherein the program code further causes the system to:
determine if the first article of interest has been previously identified in at least one other image of the plurality of images;
in response to the first article of interest having been previously identified in the at least one other image, associate the first article of interest in the first image with a first identifier previously associated with the first article of interest;
in response to the first article of interest not having been previously identified, generate a second identifier different from each identifier associated with one or more other previously identified articles of interest, and associate the first article of interest in the first image with the second identifier.

5. The system of claim 4, wherein the program code causes the system to determine if the first article of interest has been previously identified in the at least one other image of the plurality of images by:
calculating a first feature descriptor for the first article of interest;
determining if the first feature descriptor matches any previously calculated feature descriptor;
if the first feature descriptor matches any previously calculated feature descriptors, determining the first article of interest has been previously identified in the at least one other image; and
if the first feature descriptor does not match any previously calculated feature descriptors, determining the first article of interest has not been previously identified in the at least one other image.

6. The system of claim 1, wherein the program code causes the system to identify the first article of interest in the first image by:
calculating a feature descriptor for each of a plurality of image segments of the first image; and
classifying the feature descriptor of a first image segment of the plurality of image segments as belonging to a class of articles including the first article of interest.

7. The system of claim 6, wherein the program code further causes the system to:
display a bounding box around the first image segment in the first image; and
transmit the query associated with the first article of interest to the database in response to a user selecting the bounding box.

8. A method of monitoring an area, comprising:
receiving a first image of a plurality of images of the area, each of the plurality of images including a time stamp;
identifying a first article of interest in the first image;
determining a spatial location of the first article of interest based at least in part on an image location of the first article of interest in the first image;
associating the first article of interest with the time stamp of the first image and the spatial location in a database; and
in response to receiving a query associated with the first article of interest at the database, displaying a timeline for the first article of interest.

9. The method of claim 8, wherein the plurality of images includes both visible light images and non-visible light images.

10. The method of claim 9, wherein the first image is a visible light image, the first article of interest corresponds to a personal item, and further comprising:
identifying a second article of interest in the first image corresponding to a visual identifier tag that identifies a bin holding the first article of interest;
receiving a second image of the plurality of images of the area, the second image being a non-visible light image;
identifying a third article of interest in the second image corresponding to a non-visual identifier tag that identifies the bin holding the first article of interest; and
determining the first article of interest in the first image corresponds to the first article of interest in the second image based at least in part on both the visual identifier tag and the non-visual identifier tag being associated with the bin holding the first article of interest.

11. The method of claim 8, further comprising:
determining if the first article of interest has been previously identified in at least one other image of the plurality of images;
in response to the first article of interest having been previously identified in the at least one other image, associating the first article of interest in the first image with a first identifier previously associated with the first article of interest;
in response to the first article of interest not having been previously identified, generating a second identifier different from each identifier associated with one or more other previously identified articles of interest, and associating the first article of interest in the first image with the second identifier.

12. The method of claim 11, wherein determining if the first article of interest has been previously identified in the at least one other image of the plurality of images comprises:
calculating a first feature descriptor for the first article of interest;
determining if the first feature descriptor matches any previously calculated feature descriptor;
if the first feature descriptor matches any previously calculated feature descriptors, determining the first article of interest has been previously identified in the at least one other image; and
if the first feature descriptor does not match any previously calculated feature descriptors, determining the first article of interest has not been previously identified in the at least one other image.

13. The method of claim 8, wherein identifying the first article of interest in the first image comprises:
calculating a feature descriptor for each of a plurality of image segments of the first image; and
classifying the feature descriptor of a first image segment of the plurality of image segments as belonging to a class of articles including the first article of interest.

14. The method of claim 13, further comprising:
displaying a bounding box around the first image segment in the first image; and
transmitting the query associated with the first article of interest to the database in response to a user selecting the bounding box.

15. A computer program product for monitoring an area, comprising:
a non-transitory computer-readable storage medium; and
program code stored on the non-transitory computer-readable storage medium that, when executed by one or more processors, causes the one or more processors to:
receive a first image of a plurality of images of the area, each of the plurality of images including a time stamp;
identify a first article of interest in the first image;
determine a spatial location of the first article of interest based at least in part on an image location of the first article of interest in the first image;
associate the first article of interest with the time stamp of the first image and the spatial location in a database; and
in response to receiving a query associated with the first article of interest at the database, display a timeline for the first article of interest.
